(19) United States
(12) Patent Application Publication
(10) Pub. No.: US 2003/0101195 A1
(43) Pub. Date: May 29, 2003

(54) Symbol repository

(76) Inventor: Christian Linhart, Salzburg (AT)

Correspondence Address: DAVIDSON, DAVIDSON & KAPPEL, LLC, 485 SEVENTH AVENUE, 14TH FLOOR, NEW YORK, NY, 10018, US

(21) Appl. No.: 10/218,937

(22) Filed: Aug. 14, 2002

Related U.S. Application Data
(60) Provisional application No. 60/312,308, filed on Aug. 14, 2001.

(51) Int. Cl. G06F 7/00

(52) U.S. Cl. 707/102

(57) ABSTRACT

A method for organizing a plurality element entities is provided. The plurality of element entities from a source code is read. The source code comprises one or more blocks. Moreover, each block comprises source code in one of a plurality of computer languages. The element entities are inserted into a symbol repository based on a type, where the type is defined by a function of the element entity in the source code and one of a plurality of computer languages of the block. The element entities are organized in the symbol repository by grouping the element entities into one or more sets. One or more symbols are created in the symbol repository based on the sets. Each set is associated with the symbols.

This application claims priority from U.S. Provisional Application Ser. No. 60/312,308, filed Aug. 14, 2001, the entire disclosure of which is hereby incorporated by reference.

### BACKGROUND INFORMATION

A computer program can be viewed as a detailed plan or procedure for solving a problem with a computer: an ordered sequence of computational instructions necessary to achieve such a solution. The distinction between computer programs and equipment is often made by referring to the former as software and the latter as hardware. Generally, a computer program is written in a computer language. However, in order for the computer program to operate on the hardware, it is translated into machine language that the hardware understands. Moreover, the way that different operating systems interface with different types of hardware needs to be taken into account when translating the program into machine language. An operating system is a set of programs that controls the many different operations of a computer. The operating system also directs and coordinates the computer's processing of programs.

Computers can be organized into a network, for example, a client-server network. In a client-server network, the clients and a server exchange data with one-another over a physical network. Files can be exchanged and shared between the clients and servers operating on the network.

A compiler is used to translate the computer program into machine language. It may be a task of considerable difficulty to write compilers for a given computer language, particularly when the computer program is designed to operate on different types of hardware and operating systems.

Computer programs are written in a computer language, which is a formal language for writing such programs. The definition of a particular language includes both syntax (how the various symbols of the language may be combined) and semantics (the meaning of the language constructs). A set of elements is used to form the different symbols used in the language. Languages are classified as low level if they are close to machine code and high level if each language statement corresponds to many machine code instructions.

Compilers use a parser in the compilation process. A parser is an algorithm or program used to determine the syntactic structure of a sentence or string of symbols in some computer language. A parser normally takes as input a sequence of symbols output by a lexical analyzer. It may produce some kind of abstract syntax tree as output. The symbols can then be stored in a data structure, such as a symbol table or symbol repository, to facilitate the compilation process.

Elements in source code usually represent a certain parameter or language construct within a particular region of source code. Generally, the region extends from the place where the element is declared to the end of the smallest enclosing block (begin/end or procedure/function body). This region is known as the scope of the element. An inner block may contain a re-declaration of the same identifier in which case the scope of the outer declaration does not include (is “shadowed” or “occluded” by) the scope of the inner.

A computer program may also be compiled not into machine language, but into an intermediate language that is close enough to machine language and efficient to interpret. However, the intermediate language is not so close that it is tied to the machine language of a particular computer. It is use of this approach that provides the Java language with its computer-platform independence.

Since different languages use different language constructs, different symbols may have different meanings in separate languages. In order to differentiate the symbols, they are stored in separate data structures.

In some cases, the different symbols can be stored in the same data structure, such as a symbol repository. However, prior symbol repositories are compatible with at most a few languages. Moreover, the prior symbol repositories do not allow flexible parameterization with a variety of programming languages.

### SUMMARY

In accordance with a first embodiment of the present invention, a method for organizing a plurality element entities is provided. A plurality of element entities is read from a source code. The source code includes one or more blocks, and each block includes source code in one of a plurality of computer languages. The element entities are inserted into a symbol repository based on a type, where the type is a function of the element entity in the source code and one of a plurality of computer languages of the block. The element entities are organized in the symbol repository by grouping the element entities into one or more sets. One or more symbols are created in the symbol repository based on the sets. Each set is associated with the symbols.

In accordance with a second embodiment of the present invention, a method for organizing a plurality of entities is provided. A data stream is accepted, and the data stream is formed from a plurality of element entities in a source code. The source code includes one or more blocks. Moreover, each block includes source code in one of a plurality of computer languages. One or more element entities based on a type are created, where the type is a function of the element entity in the source code and one of a plurality of computer languages of the block. The element entities are organized in the symbol repository by grouping the element entities into one or more sets. One or more symbols are created in the symbol repository based on the sets. Each set is associated with the symbols.

In accordance with a third embodiment of the present invention, a method for organizing a plurality element entities in parallel is provided. A plurality of threads are created, and each thread is operative to control a computer to perform the steps of reading one or more of element entities from a source code, the source code comprising one or more blocks, inserting the element entities into a symbol repository based on a type, organizing the element entities in the symbol repository by grouping the element entities into one or more sets, creating one or more symbols in the symbol repository based on the set, and associating each set with the symbols. In this regard, each block includes source code in one of a plurality of computer languages, and the type is a function of the element entity in the source code and the one of a plurality of computer languages of the block.

### BRIEF DESCRIPTION OF THE DRAWINGS

FIG. 1 shows parser and symbol repository.

FIG. 2 shows a user interface for the symbol repository of the present invention.

FIG. 3 shows an entity-relationship diagram for a core module of the symbol repository.

FIG. 4 shows an entity relationship diagram for the multi-language entities of the core module.

FIG. 5 shows an entity relationship diagram for a precise source position embodiment of the symbol repository according to the present invention.

### DETAILED DESCRIPTION OF THE PREFERRED EMBODIMENTS

A symbol repository according to an embodiment of the present invention acts as a data object in which source code read by a parser is stored in an organized fashion. Functions, parameters, variables, and other language constructs in a source code file are broken down into elements by the parser and sent to the symbol repository. A plurality of element entities are created in the symbol repository for each element sent to the symbol repository. The element entities contain a plurality of parameters that define the element. Symbol entities, which are used to represent one or more symbols, are also created in the symbol repository and linked to one or more of the element entities. The symbol entities include parameters that define the symbol and it's relation to the source code.

The symbol repository is flexibly parameterized to deal with a variety of programming languages. To do so, a language entity is created in the symbol repository for each language used in the source code. The language entity contains a plurality of language specific parameters, which are used to define various aspects of the element entities for that particular language. The language entity is also associated with the symbols and entities that appear in the given language.

In some cases, the parameters are strings. Preferably, the strings are stored in a string table. The string table maps the strings to an identifier (e.g., string ID). Preferably, strings are do not have any internal structure. In certain embodiments, a string identifier is a non-negative number (e.g., an integer).

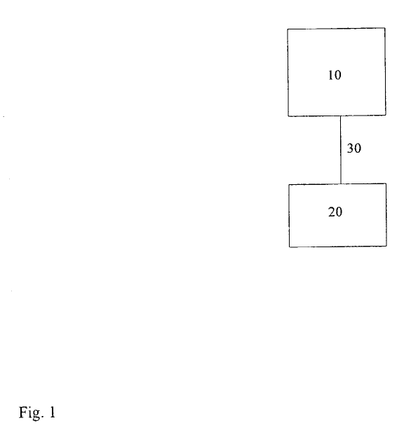

FIG. 1 shows parser 20 and symbol repository 10. Parser parses a source file and converts data in a source file to a data stream 30. Parser 20, using a symbol model similar to the symbol model used in symbol repository 10, sends data stream 30 to symbol repository 10. Data stream 30 comprises elements, symbols, source positions, bodies, body parts, string table entries, and signatures (described below). The elements, symbols, source positions, bodies, body parts, string table entries, and signatures each have an identifier, which can be a number. Symbol repository 10 translates the identifier in the incoming data stream to a corresponding identifier in symbol repository 10 by a mapping function or table. The element entities are then entered into symbol repository 10 based on their identifier.

Preferably, parser 20 unifies language elements (e.g., identifies a language element delivered by parser 20 with a language element already in symbol repository 10) within a parsing run. For class definitions, the symbol repository 10 unifies the class. Most preferably, a user can configure whether or not to unify the language elements.

Before new data is added to symbol repository 10, symbol repository 10 deletes any obsolete data. For example, symbol repository 10 can delete all body-parts (described below) which have a sourceposition pointing into the current file. Then, symbol repository 10 can delete all symbols whose sourceposition points into the current file and which do not have any body parts. After that, symbol repository 10 can delete language elements which are not used by any symbol; all of whose members are deleted; and all of whose sub-scopes in the visibility relation are deleted.

In a parallel processing embodiment, parser 20 comprises a plurality of threads, each thread sending the data stream 30. Moreover, symbol repository 10 may comprise a plurality of threads, each thread translating the incoming data stream 30 to a corresponding identifier in symbol repository 10 by a mapping function or table.

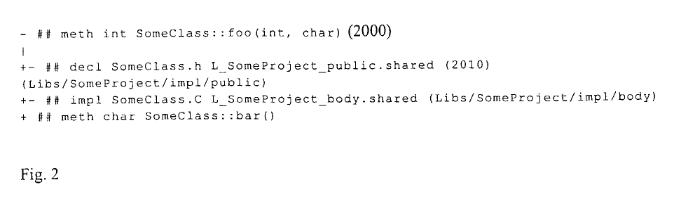

FIG. 2 shows a user interface for the symbol repository of the present invention. However, it should be appreciated that FIG. 2 is offered as an exemplary embodiment and that the symbol repository can use other types of interfaces. The user interface contains a plurality of language elements 2000. For each language element 2000, the user interface also contains a list of symbol usages 2010. Preferably, the language elements 2000 and symbol usages 2010 are arranged in a two-tired structure, wherein the language elements 2000 form the first tier and the symbol usages 2010 form the second tier. The user can then open elements of the first tier in order to show elements of the second tier. Icons (represented in FIG. 2 by “##”) are used as a graphical representation of the language elements 2000 and symbol usages 2010.

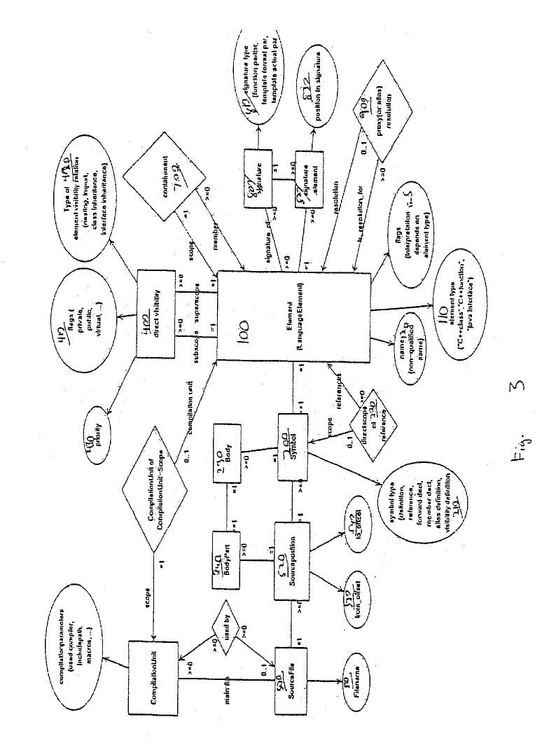

FIG. 3 shows an entity-relationship diagram for a core module of the symbol repository 10. An element entity 100 (e.g., variable, function, class, type, struct, namespace, { }-block, formal template parameter, include-directive) defines a construct used in a computer language to form symbols 200. Preferably, the element entities 100 are stored in a table. The element entity 100 may exist in one or more computer languages (e.g., JAVA, C++, LISP). The element entity 100 includes a unique identifier of this language element, for example, an auto-generated integer (not shown); a language specific type of the element (e.g., “C++ class”, “Java package”, “Pascal variable”, . . . ) 110; a name 120 (e.g., the non-qualified name of the language element); a scope identification (e.g., the unique scope containing this language element) (not shown); a type of the element (e.g., “int”, “SomeClass”, . . . ) (not shown); and a resolution (used for all alias-type structures, such as “using”, “namespace alias”, “java class import”, or proxies) (not shown).

The language specific type of the element 100 can be defined by specific language constructs. For example, in C++, it may have the following values: class, struct, enum, function (method), variable, type, constant, { }-block, function-body, formal template parameter, etc.

The type of the element can depend from the language specific type of the element. For example, if the language specific type of the element is defined as “variable,” the type of the element can be defined with the types of variables allowable in a particular language (e.g., int, long, etc.). In certain embodiments, when the language specific type defines a function or method, the type of the element can be defined by a function-pointer type or NULL. Preferably, the type can be recursively defined by another element entity 100. Moreover, the type of a type can be a special predefined element “#type#,” which is contained in the “language scope” for the language in question.

In certain embodiments, the element entity 100 may have a plurality of flags 125. The flags can be language-specific devices and relate to how the element entity 125 is used. The interpretation of the flags depends on the type of the element 10.

Each element entity 100 is associated with a direct visibility entity 400, which is used to define the scope of the element. The element entity 100 is also associated with a containment entity 700, which defines the containment relationship of a particular scope for each element entity 100.

A plurality of queries can be associated with the element entity 100. The queries can be implemented as methods in the element entity 100. A contains-query can be used to return the set of elements which are (directly or indirectly) contained in a given element entity 100. Preferably, the contains-query is implemented as a tree-traversal of the containment sub-tree starting with a particular element. Preferably, the result of the contains-query does not include the element entity 100 itself. A contains-in query is used to determine what is included in the element entity 100. For example, the contains-in query can be used to list everything contained in a element entity 100, display all methods of classes contained in a given namespace, and list local variables defined in a method. The contains-in query may be used as a sub-query in another query that is restricted to everything contained in element entity 100 (or any of its sub-elements).

The direct visibility entity 400 and containment entity 700 define the element entity's 100 scope. In the symbol repository, hierarchical scoping is used for modeling language elements which contain other language elements (e.g., classes and functions containing local variables). The scopes can be defined by one or more elements. For example, a scope can be defined by, classes, methods, { }-blocks, structs, namespaces, and/or file-scopes.

The element entity 100 is also associated with one or more symbol entities 200.

The symbol entity 200 combines the concepts of “declaration”, “definition”, and “reference” into a single concept. Included in the symbol entity 200 are a symbol identification (not shown), element reference (e.g., a language-element which is described by the current symbol) (not shown), a symbol type 210 (e.g. definition, forward decl, member decl, ref. . . . ), a srcpos (not shown), and a scope 220 (e.g., the scope in which the reference is directly located).

Each symbol 200 has exactly one position in the source code, which is modeled by the sourceposition entity 520.

The symbol type 210 can be a definition, reference, forward declaration, member declaration, alias definition (e.g., “using” in C++), or a visibility definition. Preferably, any of the types may occur several times for the same element entity 100.

A definition symbol type 210 defines a language element. C++ source code statements that are modeled as a definition are shown in Table 1.

TABLE 1

int foo::bar( ) (method definition)
{
return 42;
}
class foo (definition of class “foo”)
{
int bar( );
};
namespace baz (definition of namespace “baz”)
{
const int abc=4;
}

The symbol type 210 uses references to define usages of language elements that are defined elsewhere (e.g., assuming that “a” has been defined, then x=a or a=5). Where foo is an object and abc is method defined for the object, Foo::abc can be an example of a reference language element defining a scope whose contents are visible from the outside.

The symbol type 210 uses forward declarations when a type and name of a language element is declared, but the element's contents are not defined. For example, “class forward decl foo” and “class foo” are modeled by the forward declaration. A forward declaration may model signatures.

A member declaration declares a member of a class, struct, enums or similar structure. For example, “static int a,” and “int bar ( )” are language elements that are modeled by member declarations.

In certain embodiments, the symbol repository treats forward declarations and member declarations the same.

An alias definition symbol type 210 is used to model a proxy entity 900 at a symbolic level. Table 2 shows some examples of source code that is modeled by the alias definition.

TABLE 2
using A::f; (future, unqualified referrals to f are interpreted as A::f)
namespace VLNSN = VeryLongNameSpaceName; (namespace alias
definition in C++)
namespace foo = com::takefive::libs::foo(namespace alias definition);
import com.t5.foo (Java class import);

In case of overloaded functions, one “using”-declaration may define multiple aliases. Moreover, each using-declaration opens a new scope because the using declaration affects language elements which occur after it.

A visibility symbol type 210 introduces a new scope to the symbol entity 200 and adds a new edge to a direct visibility relation graph (not shown). A visibility definition can be used to define the language parts in the source code that are the visibility symbol types 210. For example, the statements “using namespace base,” and “import com.t5” can be defined as language parts that are modeled by the visibility symbol type 210.

In certain embodiments, the symbol entity 200 is associated with one or more body entities 230. Each body entity 230 contains a source code part. Non-connected parts of source code and parts of the source code from different files may be part of the body entity 230. For example, a #include statement can be inside of a body entity 230 or a macro call can be inside of the body entity 230.

The body entity 230 is represented by the sourceposition entity 520. A body parts (BP) entity 240 acts as an interface between the body entity 230 and sourceposition entity 520. The body entity 230 can have more than one body part entity 240. Moreover, each body part entity 240 can be associated with more than one sourceposition entity 520. To associate with a particular body entity 230, the body part entity 240 uses an identification of body field. Likewise, to associate with a particular soucepostition entity 520, the body part entity 240 uses an identification of sourceposition field.

In certain embodiments, the body entity 230 may be identified with a symbol entity 200 as an optimization. In such an embodiment, since there is a 1:1 relationship between the symbol entity 200 and the body entity 230, the body entity 230 does not use an Identifier of its own.

In certain embodiments, where a preprocessor causes a symbol name or a declaration to be distributed to a number of places, the position of the symbol name can be modeled the same way as the body entity 230 or body part entity 240.

The sourceposition entity 520 describes the position of the element 100 in the source code. Preferably, the sourceposition entity 520 describes a connected part of a source file.

The sourceposition 520 includes the following data: identification of a given file (to reference a particular file); from-pos (to locate a particular item in given file), and to-pos (also to locate a particular item in given file). Preferably, the from-pos and to-pos are of the types from_offset 530 and to_offset 540. Preferably, the from-pos and to-pos are used to find a location within a source file with respect to an offset value. In languages with a preprocessor, such as C++, the source position entity 520 may contain extended fields to accommodate data generated by the preprocessor (e.g., the from-pos and to-pos are modeled with extended fields).

The sourcefile entity 500 models one or more source files that are used during the compilation process. Preferably, the sourcefile entity 500 is implemented as a table that contains all the source files. The key used to access this table can be a simple identifier (e.g., an integer). The sourcefile entity 500 contains an identifier for a particular file (not shown), name of the file 510, and an identifier for the project that the source file forms a part of (not shown). The identifier for the project denotes which project contains the current source file. The name of the file 510 is a character string that references a particular source file. The character string can be a pre-set length, for example, 256 characters. More than one sourcefile 500 can be associated with more than one source position 520.

The direct visibility entity 400 directly defines the visibility information about the element entity 100 as it relates to a language concept or construct with regard to a particular scope (e.g., subscope or superscope). The direct visibility entity 400 is defined by an INT priority (not shown), one or more base scope identifications (not shown), one or more superscope identifications (not shown), an identification for a symbol visibility type 420, and one or more flags 410 (e.g., “virtual”, “public”, or “private” for C++ class inheritance). The base scope identification is used to associate the visibility entity 400 with a base scope, and the superscope identification is used to associate the visibility entity 400 with a superscope.

Preferably, the visibility information is modeled as a reflexive function (i.e., the symbols defined in a scope are visible in that scope).

The symbol visibility types 420 can be nesting visibility, import visibility, class inheritance, and interface inheritance.

Nesting visibility allows each scope nested within another scope to inherit all elements defined in the surrounding scope.

In certain embodiments, the scope can be nested in multiple scopes. For example, scope “A” can be nested in both scopes “B” and “C”. In such an embodiment, a priority 430 data element, which can be located in the direct visibility entity 400, defines which scope has priority (i.e., which scope is the superscope). Preferably, the priority 430 is a fixed superscope for resolving name clashes. A nameclash results when one scope directly inherits the same element from two or more scopes (e.g., A inherits element E from scopes B and C).

The import symbol visibility type 420 allows visibility information from an otherwise separate entity to be used with the current entity. For example, ImportVisibility allows using namespace base in C++ and import com.takefive in JAVA.

The class inheritance symbol visibility type 420 allows a derived class to inherit one or more elements 100 from another class.

Preferably, the flags 410 include parameters for public inheritance vs. private inheritance and virtual inheritance. In this context, the term “private” acts at an access-rights level and not the scope level. Consequently, elements that are defined as “private” are visible at a particular scope level.

In certain embodiments, indirect language element visibility is derived from direct visibility by dynamically applying a depth first search to the directed graph defined by the direct visibility. Indirect language element visibility is transitive: if scope “A” is visible to scope “B”, and scope “B” is visible to scope “C” then scope “A” is visible to scope “C.” The indirect language element visibility may contain circles (i.e., scope “A” is visible to scope “B”, scope “B” is visible to scope “C”, and scope “C” is visible to scope “A”).

Preferably, the indirect language element visibility is stored in a cache or modeled as a separate entity.

The containment entity 700 defines a containment relation for each scope of an element entity 100. An element entity 100 can be associated with more than one containment entity 700. In certain embodiments, the containment entity 700 is modeled by a tree structure. Preferably, the fully qualified name of the scope of the element entity 100 is concatenated with a scope delimiter and the non-qualified name of the element entity 100 to yield a fully qualified name of the element entity 100. The fully qualified name is then stored in the containment entity 700.

Preferably, containment of a language elements in scopes is universal (i.e., is not restricted to several types of language elements). For example, C++ allows functions to be declared within classes, while Java 1.1 allows class definitions within classes and methods. Restrictions relating to containment are, preferably, handled by a parser. The containment entity 700 supports direct containment relations (e.g., a tree structure), full containment relations, and indirect containment relations. Different queries relating to an elements visibility can be implemented as methods in the containment entity 700. A scopes-visible-from-scope query returns the set of scopes whose elements are visible from inside the scope defined by a given element. This does not mean that these elements are actually used in the given element, but that they are visible from inside the given element without qualification. Preferably, the scopes-visible-from-scope query does a recursive traversal of the visibility graph. The result of this query may contain the given element.

In certain embodiments, instead of returning the set of scopes, the return is a list which is ordered according to a priority for nameclashes. In such an embodiment, a depth-first traversal of each scope in priority order is used. Preferably, an additional priority-field which denotes position in the list is also used.

An elements-visible-from-scope query returns the set of elements which are visible from inside the scope defined by the given element. This query may be implemented similarly to the scopes-visible-from query, but returns the elements contained in the scopes traversed.

In certain embodiments, the elements-visible-from query may be defined on top of the scopes-visible-from query. Referring to Table 3, assume that the scopes visible from an element (SVFE) is a view containing the result of scopes-visible-from (element).

TABLE 3

SELECT * FROM Element JOIN SVFE ON Element.scope =
SVFE.ElementID

GROUP BY Element.name
HAVING SVFE.PRIORITY = MIN(SVFE.PRIORITY)

In such an embodiment, the elements-visible from query uses the full visibility relation (i.e. transitive hull of the direct visibility relation) and the direct containment relation.

Preferably, the elements-visible-from query can be restricted to specific visibility-types. In certain embodiments, the elements-visible-from query resolves name-clashes. Preferably, the above mentioned queries may be used for providing completion-lists like the ones in the Visual-Basic or Visual-C++ editor.

A scope-is-visible-in query returns the set of scopes where the elements of the given scope are visible. This query is similar to the scope-visible-from query, except that the visibility graph is traversed in the opposite orientation. Preferably, the scope-visible-from query may also be restricted to a set of visibility types. In certain embodiments, the scope-is-visible-in query can be overloaded to return the set of subclasses of a class (including the class itself).

An element-is-visible-in query returns the set of scopes in which the given element is visible. The element-is-visible-in query may return a subtype of the query because it has to take into account that the element may be shadowed by equally named elements. In certain embodiments, the element-is-visible in query works as the scope-is-visible-in query, but stops traversal of the visibility graph as soon as a scope contains an element which shadows the given element.

A signature entity 800 is used to implement signatures for certain types of element entities 100, such as overloaded methods, functions, operators, and templates (e.g., C++ templates). The signature entity 800 comprises a signature type 810 (e.g., function parameter list, template parameter list, or template actual parameter) and one or more signature elements 820. The signature elements 820 form a parameter list, which can be used to distinguish the structure that the signature is modeling. The signature elements can be modeled by the element entity 100. Each signature element 820 has a position 830 in order to keep track of its location.

In C++ and Java, functions and methods are identified not only by their scope and name, but also by their parameter lists. This allows use of the same function name for multiple functions. Moreover, in the case of overloading, the same function name can be used for functions that perform similar operations to different variable types. As such, the symbol service compares parameter lists of signature entities 820 in order to exactly match specific overloaded functions. However, in certain embodiments, non-exact matching may be performed (e.g., by the second pass of the fuzzy C++ parser).

There are four signature types 810: formal template parameters (for a template declaration/definition), actual template parameters (for an instantiated template), return type signatures, and function parameter lists.

Actual template signature types 810 can be types or constants, both of which are language elements. Consequently, actual template signature types 810 are modeled as a list of elements (like a function or parameter list).

Preferably, formal template signature types 810 are modeled as partial template specialization.

Type conversion operators (operators determined by their class and by their return type), are modeled by naming them “operator” and using the return-type signature type 810. Preferably, the delimiters for the return-type signature type 810 are and “ ” for start and end respectively.

Preferably, type-conversion operator templates, such as template<class T>operator T ( ) and template<class T>operator T* ( ), are modeled as overloaded versions of type-conversion operators.

A Proxy entity 900 (i.e., aliases) is used to address unresolved references and symbol aliases. The proxy entity 900 includes a resolution field. The resolution field acts as a link to the element entity 100 for which the proxy entity 900 is a place holder. Preferably, if the proxy entity 900 is used to model an unresolved reference, the resolution is NULL.

In certain embodiments, proxy entities 900 are used to model namespace aliases or the “using” construct in C++.

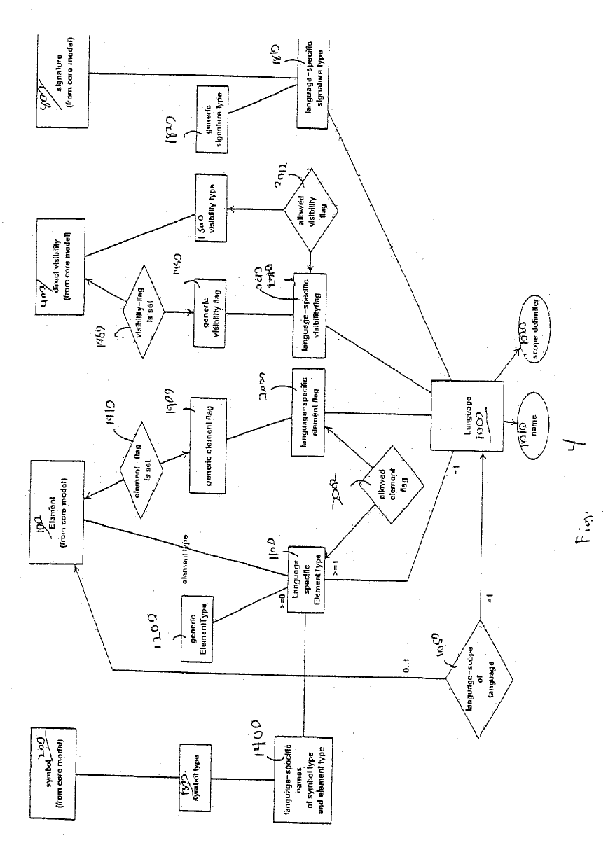

FIG. 4 shows an entity relationship diagram for the multi-language entities of the core module. The symbol entity 200, element entity 100, direct visibility entity 400, and the signature entity 800 are shown.

One or more language entities 1000 are used to support different languages. Each language entity 1000 is used to model a particular language. The language entity 1000 includes a language identifier, language name 1010, and a scope delimiter 1020. Preferably the language entity 1000 also contains the revision of the language (not shown). The language name 1010, scope delimiter 1020, and revision of the language can be strings.

The symbols types 210 of the symbol entity 200 can be modeled in a separate symbol type entity 1300. Most preferably, the symbol type entity 1300 uses a table to organize its parameters. In certain embodiments, the table uses an integrity checking mechanism. In some embodiments, the symbol types 210 are not modeled as a separate entity, instead the symbol types 210 remain part of the symbol entity 200 and the element type entity 1400 is associated with the symbol entity 200.

The type of the visibility entity 420 of the direct visibility entity 400 can be modeled as a visibility type entity 1500 to facilitate new visibility types that may occur in different languages. However, in certain embodiments the visibility type entity 1500 is not modeled as a separate entity, instead it remains part of the visibility entity 420.

Also, the signature type 810 of the signature entity 800 can be modeled as a language-specific signature type (LSST) entity 1810. The LSST 1810 includes an identification of the language (not shown), generic signature type identification (not shown), start of signature (e.g., “(”, “<”) (not shown), end of signature (e.g., “)”, “>”) (not shown), and element separator (e.g., “, ”) (not shown). The LSST 1810 is used to model signatures that are specific to a particular language. However, in certain embodiments the LSST entity 1810 is not modeled as a separate entity, instead it remains part of the signature entity 800 and the language entity 1000 is associated with the signature entity 800.

A generic signature type entity 1820 is used to model signatures that are the same across different language platforms.

In multi-language embodiments such as the embodiment shown in FIG. 4, each element entity 100 may have a set of flags. The allowed set, naming, and semantics of the flags depends of the current language specific element type.

A generic element flag entity 1900 defines the address in the flags-attribute of the element entity 100. The generic element flag entity 1900 includes an identification (not shown), name (not shown), an address (not shown), and “is set” 1910 attribute. In certain embodiments, the address can be used as the generic element flag identifier. The generic element flag entity 1900 can be used for differently named flags in different languages that do the same thing.

Each direct visibility entity 400 may also have a set of flags. A generic visibility flag entity 1950 defines any visibility flags associated with the direct visibility 400 entity. The generic visibility flag entity 1950 includes a identification for the generic visibility element flag (not shown), name of the flag (not shown), address (not shown), and “visibility is set” 1960 attribute. In certain embodiments, the address can be used as the identification for the generic visibility element flag. The generic visibility flag entity 1900 can be used for differently named flag in different languages that do the same things with regard to visibility.

One or more language specific element flags 2000 and one or more language specific visibility flags 2010 model language specific flags used in the language entity 1000. The language specific element flags 2000 and language specific visibility flags 2010 act with regard to the element entities 100 and the direct visibility entities 400, respectively. The language specific element flags 2009 and language specific visibility flags 2010 both contain the same attributes. The attributes are an identification of the flag (not shown), identification of which language associates with the flag (not shown), name of the flag (not shown), isNegation, and an allowed field 2010,2012. A many-to-many relationship exist between the flags 2000,2012 and their respective entities 100,400.

A language-scope of language entity 1050 defines the scope of the element entity 100 within a particular language 1000.

Each language defines a set of language element types, which are modeled by the language specific type entity (LSET) 1100. Through the LSET 1100, each element entity 100 can indirectly access its respective language entity 1000.

The language specific type entity 1100 includes an identification of which language associates with the LSET 1100 (not shown), name (commonly used to describe the language element), and an identification of a semantic concept (describes the semantic) (not shown). Preferably, the LSET 1100 uses a table to organize the language element types.

In certain embodiments an identification of the language element type acts as a an identifier for the particular LSET 1100.

A Generic Element-Type (GET) entity 1200 models language elements from different languages that share the same or similar semantic concepts. Preferably, the GETs 1200 are modeled as a table, wherein the table links the language specific element types 1100 to the generic element types 1200. The GET can use a generic element type identifier as a key in the table.

A language specific names of symbol type and element type entity (LSNSTE)1400 provides a link between the symbol type entity 1300 and the LSET 1100. The LSNSTE 1400 includes a symbol type (not shown), name of the element type (the name of the element-type in this context) (not shown), a name of the symbol type (the name of symbol-type in this context) (not shown), and a combined name field (the combined name for the symbol type and the element type) (not shown).

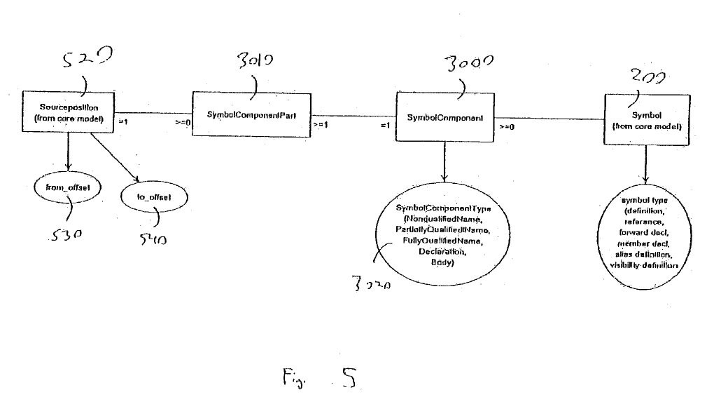

FIG. 5 shows an entity relationship diagram for a precise source position embodiment of the symbol repository according to the present invention. The source position entity 520 and symbol entity 200 are shown. Also shown are the from_offset 530 and to_offset 540 parameters. The body entity 230 can be modeled by the symbol component entity 3000. Moreover, the body part entity 240 can be modeled by the symbol component part entity 3010. A symbol component type 3020 is added to the symbol component entity 3000. The symbol component type 3020 can be, for example, a non-qualified name, partially qualified name, fully qualified name, declaration, or body.

A plurality of queries (described below) may be implemented as methods in any of the above mentioned entities or objects (FIGS. 1-5). The queries allow access to the data in the symbol repository of the present invention.

A contained-in query can be used to return a set of data elements which contain a given data element. Preferably, the contained-in query is implemented as an up-tree traversal of a containment-tree until the root of the tree is reached. The contained-in query can be overloaded to accept filters according to a set of element types.

In certain embodiments, the contained-in query is modified to generate the partially or fully qualified names. Table 4 shows a pseudo-code implementation of such an embodiment.

TABLE 4
GET_FQEN(E) //fully qualified element name
{

STRING qname=“”;
while E != theRootScope

STRING name = E.name; //get the unqualified name of E
if name != “” then

qname = name + scopeDelimiter + qname;

endif
E = E.scope; //go to the scope containing E

endwhile
return qname

}

In Table 4, “E” stands for the element for which the partially qualified name is being computed.

Preferably, when the qualified name for a signature is calculated, the name of the signature is added to the qname.

A get-all elements query can be used to get all the elements matching a fully qualified element name. This is done by a get-elements-for fully qualified name query with qname parameter specifying the element name, and a lang specifying the language. Qname is then split into a list L of non-qualified names. Splitting is done at each occurrence of the scope delimiter of “lang”. Then, starting with the language-scope of the language, the containment tree is recursively descended while subsequently matching the names of the list L with the non-qualified names of the scopes. The list of elements found at a level where all elements of list L are matched on descending the containment hierarchy is then returned.

Preferably, the tree traversal is a depth-first traversal.

Preferably, if signatures are used in the query, then they are parsed and matched, also.

In order to generate the partially qualified names an additional while-condition is added to Table 4. Preferably, the while-condition is based on the element type for which the partially qualified name is being computed. For example, the loop may exit as soon as a namespace is being found, so that the partially qualified name, not including namespace qualification, is computed.

A first referred-by query are used to list all references of a given element and find all references of the given element. A second referred-by query is used to return all other elements which directly or indirectly contain the given element.

The first referenced-by query (return list of references) is a simple filter on the symbol table. The second referenced-by query (return list of elements containing the references) uses inclusive-contained-in query for the scope of each reference found in the query for the first referenced-by query. Table 5 shows pseudo-code for the second referenced by query.

TABLE 5
REFBY_CONTAINERS(E, ELETYPES): (E stands for a given element
type, and ELETYPE stands for the type of the given element)
The view DIRECT_REFBY_CONTAINERS is defined as follows
SELECT Element.* FROM Symbol INNER JOIN Element ON
Symbol.scope = Element.elementID

WHERE Symbol.element = E AND symbolType = “reference”

SELECT DISTINCT Element.* FROM Element,
DIRECT_REFBY_CONTAINERS

WHERE Element.elementID IN INCLUSIVE_CONTAINED_IN(

DIRECT_REFBY_CONTAINERS.elementID, ELETYPES)

For each element of REFCONTAINERS an inclusive-contained-in query, possibly filtered by a set of element types (ELETYPES) is performed and duplicates of the result are removed.

A refers-to query is a variant of a contained-in query. Instead of returning all sub-elements of a given element, the refers-to query returns all references contained in these sub-elements. It may also return the elements of these references.

A get-element query is used in the parser, Xref-engine, or an editor. The get-element query returns the element referred to by a non-qualified name, N, in a scope E. The get-element uses a recursive traversal of the visibility graph while querying for the name N in each scope.

Preferably, the get-element query supports signatures. The get-element query can then support additional filtering by signatures.

In the preceding specification, the invention has been described with reference to specific exemplary embodiments thereof. It will, however, be evident that various modifications and changes may be made thereto without departing from the broader spirit and scope of the invention as set forth in the claims that follow. The specification and drawings are accordingly to be regarded in an illustrative manner rather than a restrictive sense.

What is claimed is:

1. A method for organizing entities comprising the steps of:
reading a plurality of entities from a source code;
inserting the entities into a symbol repository; and
organizing the entities in the symbol repository.

2. A method for organizing a plurality element entities comprising the steps of:
reading the plurality of element entities from a source code, the source code comprising one or more blocks, each block comprising source code in one of a plurality of computer languages;
inserting the element entities into a symbol repository based on a type, wherein the type is a function of the element entity in the source code and the one of a plurality of computer languages of the block;
organizing the element entities in the symbol repository by grouping the element entities into one or more sets;
creating one or more symbols in the symbol repository based on the sets; and
associating each set with the symbols.

3. A method for organizing a plurality of entities comprising the steps of:
accepting a data stream, the data stream formed from a plurality of element elements in a source code, the source code comprising one or more blocks, each block comprising source code in one of a plurality of computer languages;
creating one or more element entities based on a type, the type defined by a function of the element entity in the source code and the one of a plurality of computer languages of the block;
organizing the element entities in the symbol repository by grouping the element entities into one or more sets;
creating one or more symbols in the symbol repository based on the sets; and
associating each set with the symbols.

4. A method for organizing a plurality element entities in parallel comprising:
creating a plurality of threads, each thread operative to control a computer to perform the steps of:
reading one or more of element entities from a source code, the source code comprising one or more blocks, each block comprising source code in one of a plurality of computer languages;
inserting the element entities into a symbol repository based on a type, the type defined by a function of the element entity in the source code and the one of a plurality of computer languages of the block;
organizing the element entities in the symbol repository by grouping the element entities into one or more sets;
creating one or more symbols in the symbol repository based on the sets; and
associating each set with the symbols.

5. The method as recited in claim 2 wherein the blocks further comprise source code in one of a plurality of scopes; and wherein the type is a function of the one of a plurality of computer languages in the scope and the element entity in the source code.

6. The method as recited in claim 5 further comprising creating one or more direct visibility entities based on the scope and one of the computer languages, each direct visibility entity comprising a type of the visibility relation; and associating each element entity with at least one of the visibility entities.

7. The method as recited in claim 2 wherein the blocks further comprise source code in one of a plurality of namespaces; and wherein the type is further defined by a function of the one of a plurality of computer languages in the namespace.

8. The method as recited in claim 7 further comprising creating one or more signature entities based on the namespace, the element entity, and one of the computer languages, each signature entity further comprising a list of signature elements for the element entity with regard to the namespace; and associating each signature entity with at least one of the element entities.

9. The method as recited in claim 2 further comprising creating one or more source position entities based on the symbols, each source position entity describing the one or more locations within the block of the symbols; and associating each symbol with one of the source position entities.

10. The method as recited in claim 2 further comprising creating one or more language entities for each of the computer languages; and associating each element entity with one of the language entities.

11. The method as recited in claim 10 further comprising creating one or more language flags for each of the computer languages, each of the flags based on one or more original flags in the computer language; and associating each flag with one of the language entities.

12. The method as recited in claim 3 wherein the blocks further comprise source code in one of a plurality of scopes; and wherein the type is a function of the one of a plurality of computer languages in the scope, and the element entity in the source code.

13. The method as recited in claim 12 further comprising creating one or more direct visibility entities based on the scope and one of the computer languages, each direct visibility entity comprising a type of the visibility relation; and associating each element entity with at least one of the visibility entities.

14. The method as recited in claim 3 wherein the blocks further comprise source code in one of a plurality of namespaces; and wherein the type is further defined by a function of the one of a plurality of computer languages in the namespace.

15. The method as recited in claim 14 further comprising creating one or more signature entities based on the namespace, the element entity, and one of the computer languages, each signature entity further comprising a list of signature elements for the element entity with regard to the namespace; and associating each signature entity with at least one of the element entities.

16. The method as recited in claim 3 further comprising creating one or more source position entities based on the symbols, each source position entity describing the one or more locations within the block of the symbols; and associating each symbol with one of the source position entities.

17. The method as recited in claim 3 further comprising creating one or more language entities for each of the computer languages; and associating each element entity with one of the language entities.

18. The method as recited in claim 17 further comprising creating one or more language flags for each of the computer languages, each of the flags based on one or more original flags in the computer language; and associating each flag with one of the language entities.

19. The method as recited in claim 4 wherein the blocks further comprise source code in one of a plurality of scopes; and wherein the type is further defined by a function of the one of a plurality of computer languages in the scope.

20. The method as recited in claim 19 further comprising creating one or more direct visibility entities based on the scope and one of the computer languages, each direct visibility entity comprising a type of the visibility relation; and associating each element entity with at least one of the visibility entities.

21. The method as recited in claim 4 wherein the blocks further comprise source code in one of a plurality of namespaces; and wherein the type is further defined by a function of the one of a plurality of computer languages in the namespace.

22. The method as recited in claim 21 further comprising creating one or more signature entities based on the namespace. the element entity, and one of the computer languages, each signature entity further comprising a list of signature elements for the element entity with regard to the namespace; and associating each signature entity with at least one of the element entities.

23. The method as recited in claim 4 further comprising creating one or more source position entities based on the symbols, each source position entity describing the one or more locations within the block of the symbols; and associating each symbol with one of the source position entities.

24. The method as recited in claim 23 further comprising creating one or more language entities for each of the computer languages; and associating each element entity with one of the language entities.

25. The method as recited in claim 4 further comprising creating one or more language flags for each of the computer languages, each of the flags based on one or more original flags in the computer language; and associating each flag with one of the language entities.

26. A system for organizing a plurality of element entities, comprising:
a computer processor coupled to a memory;
the memory comprising source, the source code comprising a plurality of element entities;
the computer processor reading the plurality of element entities from the source code, the source code comprising one or more blocks, each block comprising source code in one of a plurality of computer languages;
inserting the element entities into a symbol repository based on a type, the type defined by a function of the element entity in the source code and the one of a plurality of computer languages of the block;
organizing the element entities in the symbol repository by grouping the element entities into one or more sets;
creating one or more symbols in the symbol repository based on the sets; and
associating each set with the symbols.
